(19) United States
(12) Patent Application Publication
(10) Pub. No.: US 2025/0211510 A1
(43) Pub. Date: Jun. 26, 2025

(54) METADATA BASED FUNCTION AUGMENTATION AND ORCHESTRATION IN TELECOMMUNICATION NETWORKS

(71) Applicant: DISH Wireless L.L.C., Englewood, CO (US)

(72) Inventor: Matthew Daniel Kniess, Lakewood, CO (US)

(21) Appl. No.: 18/391,387

(22) Filed: Dec. 20, 2023

(51) Int. Cl. H04L 43/10; G06F 16/906

(52) U.S. Cl. CPC H04L 43/10; G06F 16/906

(57) ABSTRACT

Methods, systems, and apparatus, including computer programs encoded on computer storage media, for providing metadata information associated with a route of a data packet through various nodes of a cellular network. One of the methods includes receiving, at one or more computing devices, metadata information indicative of a route of a data packet through various nodes of a cellular network; updating, by the one or more computing devices, a metadata record representing the data packet to include the metadata information indicative of a route of the data packet through the various nodes; and providing, in response to a query received from an entity associated with the cellular network, metadata information associated with the route of the data packet through the various nodes.

### TECHNICAL FIELD

This specification generally relates to wireless communication.

### BACKGROUND

The technology pertains to tracking and processing data that is routed through telecommunication networks such as 5G open radio access networks (5G O-RANs). For example, a data packet routed through a 5G O-RAN network can traverse various physical or functional nodes such as devices, services, or modules.

### SUMMARY

In one aspect, this document describes a method that includes receiving, at one or more computing devices, metadata information indicative of a route of a data packet through various nodes of a cellular network, and updating, by the one or more computing devices, a metadata record representing the data packet to include the metadata information indicative of a route of the data packet through the various nodes. The metadata record is a portion of a unified database maintained to keep track of various data packets traversing the cellular network. The method also includes providing, in response to a query received from an entity associated with the cellular network, metadata information associated with the route of the data packet through the various nodes.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

For example, in another aspect, this document describes a system that includes one or more computers, and one or more computer memory devices that are interoperably coupled with the one or more computers and includes tangible, non-transitory, machine-readable media storing one or more instructions that, when executed by the one or more computers, perform various operations. The operations include receiving, at one or more computing devices, metadata information indicative of a route of a data packet through various nodes of a cellular network, and updating, by the one or more computing devices, a metadata record representing the data packet to include the metadata information indicative of a route of the data packet through the various nodes. The metadata record is a portion of a unified database maintained to keep track of various data packets traversing the cellular network. The operations also include providing, in response to a query received from an entity associated with the cellular network, metadata information associated with the route of the data packet through the various nodes.

In another aspect, this document describes a non-transitory, computer-readable medium storing one or more instructions executable by a computer system to perform various operations. The operations include receiving, at one or more computing devices, metadata information indicative of a route of a data packet through various nodes of a cellular network, and updating, by the one or more computing devices, a metadata record representing the data packet to include the metadata information indicative of a route of the data packet through the various nodes. The metadata record is a portion of a unified database maintained to keep track of various data packets traversing the cellular network. The operations also include providing, in response to a query received from an entity associated with the cellular network, metadata information associated with the route of the data packet through the various nodes.

The foregoing and other embodiments can each optionally include one or more of the following features, alone or in combination. In some implementations, a node of the various nodes includes any one of: a service, a device, or an application.

In some implementations, a determination is made that a category of one or more categories of metadata information is associated with an action for the category, wherein the action includes any one of: encrypting data associated with the category, masking data associated with the category, protecting data associated with the category, formatting data associated with the category, or labeling the category. Responsive to determining that the category is associated with an action for the category, the action is performed.

In some implementations, the metadata information indicative of the route of the data packet through the various nodes includes one or more tags corresponding to the one or more of the various nodes. In some implementations, the one or more tags include any one of: a regulatory tag, a privacy tag, a timestamp tag, or a safety tag. In some implementations, the one or more tags are consumer-defined.

In some implementations, the query includes a compliance-related query, and providing the metadata information includes: filtering metadata records of the unified database by the one or more tags associated with the compliance-related query, and providing information associated with the route of one or more data packets associated with metadata records corresponding to the one or more tags.

In some implementations, metadata information indicative of a route of a second data packet is received through the cellular network, and a determination is made that the unified database does not include a corresponding metadata record for the second data packet. Responsive to determining that the unified database does not include a corresponding metadata record for the second data packet, a second metadata record representing the second data packet is generated in the unified database.

In some implementations, the unified database is any one or more of: a relational database or a graph database. In some implementations, a user-interface is provided for presentation on a user device, the user-interface configured to represent information from the unified database. The information includes metadata records from the unified database filtered in accordance with one or more tags.

Advantages of the systems and methods described in this disclosure may include those described below and elsewhere in this disclosure.

The technology described herein provides an efficient and scalable system for identifying, tracking, and addition of information at a centralized location about data that is routed through a 5G O-RAN network, such that various automation functionalities may be enabled by accessing the information stored at the centralized location. For example, the system can identify, keep track of, and/or classify which services/nodes have accessed data packets routed through the network. The system can include a metadata record representing the data packet in a unified database. By maintaining and updating the unified database, also referred to as a metadata catalog, at a central storage location (e.g., a cloud storage application) accessible to various entities, the system can keep track of a particular data packet's path through the network without adding overhead to the particular data packet itself. Furthermore, storing the unified database that includes metadata records on a cloud-based system allows for efficient scaling of the unified database to include information for arbitrarily large numbers of data packets.

The system also allows for defining/using various tags (including consumer-defined tags) and classifications for the metadata records representing corresponding data packets. The tags can allow for efficient sorting, filtering, and use of the information in the unified database, which in turn can save computing time and resources during processing of the information. For example, the system can use tags to keep track of which physical and logical/functional nodes have accessed which categories of data of the data packet. As an example, the system can use a tag to classify a category of data as a protected category of data. The system can use tags to track which nodes have accessed the protected category of data. The system can also use classifications for categories of metadata. For example, the system can classify certain categories as being associated with certain actions. The system can ensure that the data associated with the category is encrypted as the data packet is routed through the network. The system can also provide definitions of the categories of information in each metadata record, allowing consumers to better understand the data flow through the network. The system can also provide downstream processing tasks and programs with consistent and standardized information, allowing for efficient processing. The system can also enable downstream processing tasks and programs to use the tags and classifications, enabling automation and orchestration.

It is appreciated that methods and systems in accordance with the present disclosure can include various combinations of the aspects and features described herein. That is, methods and systems in accordance with the present disclosure are not limited to the combinations of aspects and features specifically described herein, but also may include other combinations of the aspects and features provided.

The details of one or more implementations of the subject matter described in this specification are set forth in the accompanying drawings and the description below. Other potential features, aspects, and advantages will become apparent from the description, the drawings, and the claims.

### BRIEF DESCRIPTION OF THE DRAWINGS

FIG. 1 is a block diagram of an example cellular network.

FIG. 2 is a block diagram of an example environment for providing metadata information associated with a route of a data packet through various nodes of a cellular network.

FIG. 3 is a flow diagram of an example process for providing metadata information associated with a route of a data packet through various nodes of a cellular network.

FIG. 4 is a block diagram of a computing system that can be used in connection with computer-implemented methods described in this specification.

Like reference numbers and designations in the various drawings indicate like elements.

### DETAILED DESCRIPTION

Implementation of a 5G-ORAN network can be represented as a collection of physical, logical, and/or functional nodes such as devices, services, and modules provided by the network provider, vendors, or other third party entities that work cooperatively to provide the functionalities of the cellular network. A data packet within a 5G-ORAN network may be routed through various nodes whose providers may need to analyze the route of and access to the packet. In addition, because various entities access the data packets, audit functionalities directed to tracking the route of and access to the packets are often important to provide a secure network. For example, for reasons such as those related to security, privacy, or regulatory compliance, various entities (e.g., a third-party vendor, a subscriber, or a service provider associated with the 5G network) may need information about how particular data packets have been routed through the network, and/or which services, devices, or applications have accessed the particular data packets. For example, various entities may need information about how particular data packets have been routed through the network to determine compliance with data policies. Various entities may also need to identify categories of data, such as sensitive data or data that should be protected.

One way to track packets can include adding information to the packet itself, such as in the header of the packet. For example, accessing entities (e.g., devices or services) can add information in the packet header. However, adding tracking information to packets increases the overhead and can create bandwidth issues as packets visit large numbers of nodes. Also, having a header format that can be deciphered by various vendors and third party entities that operate substantially independent of one another can be challenging. For example, this information may not be conducive to processing by entities that do not have information about the format of the header for example.

Overall, the absence of a universally interpretable metadata taxonomy for performing operations such as classification and tagging can make it challenging for disparate entities to understand/analyze the metadata associated with the various data packets. In particular, for a large scale system such as a 5G O-RAN network serviced by various third-party vendors and service providers, tracking and storing arbitrarily large amounts of metadata that can be efficiently processed by various disparate entities is challenging.

The technology pertains to improving the efficiency of tracking and processing data that is routed through telecommunication networks such as 5G O-RANs in a scalable manner. The technology described in this document addresses the above issues by providing a technique in which data packets traversing the network are tracked and corresponding records are maintained at a centralized location accessible to various vendors, third party entities, and auditing entities, for example. Information can be added to the record, e.g., periodically or upon visiting a new node, to capture the route of and access to data packets. The route of the data packets and access to the data packets can be captured such that the added information can be used to automate various functionalities.

For example, the techniques can include receiving metadata information indicative of a route of a data packet through nodes of a cellular network. For example, metadata information indicative of a route of a data packet through nodes of a cellular network can include the nodes of the route. Metadata information indicative of a route of a data packet through nodes of a cellular network can also include information representing which nodes accessed which categories of data of the data packet. The techniques can also include updating a metadata record for the data packet to include the metadata information. In response to a query from an entity, the techniques can include providing the metadata information for the data packet.

The techniques can also provide for filtering and sorting the metadata information for different data packets, and automating the performing of certain actions on the data corresponding to the metadata information. For example, the metadata information can include information about the types of data of the data packets. For example, some types of data may be sensitive. The metadata information can include classifications that indicate the data associated with certain categories of metadata are sensitive and should be protected. An entity associated with the cellular network such as an operator of the cellular network can ensure that the categories of data are protected as the data packets are routed through the cellular network. Another entity associated with the cellular network can perform downstream processes or automated processes using the classifications. For example, the entity can quickly identify which categories of data are sensitive. In addition, the entity can identify which nodes accessed a protected category of data. The entity can use the classifications to confirm compliance to data policies, or to implement automation for protection of the protected categories of data during downstream processing of the protected categories of data.

As another example, some categories of data may be associated with entitlements that limit access to the category of data of the data packet. For example, some nodes may have privileges to access the category of data. The metadata information can include classifications for certain categories of metadata that indicate the data associated with those categories should only be accessible to certain nodes. An operator of the cellular network can use the classifications to ensure that the data are accessible only to nodes with privileges. The system can provide the data to entities that have the correct privileges for downstream processing.

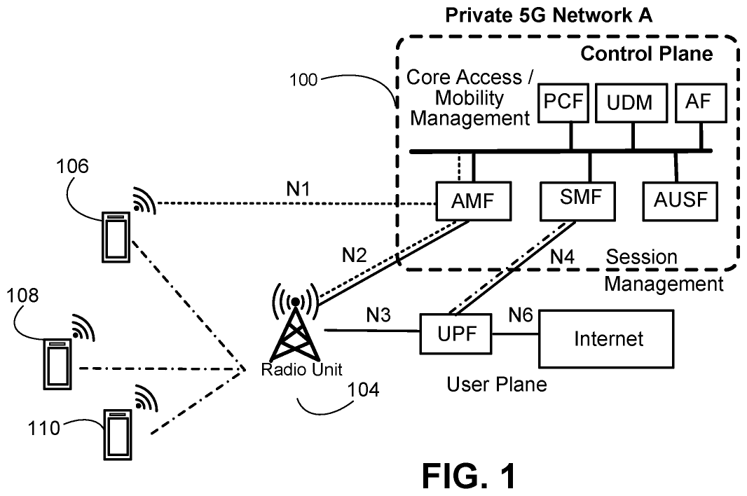

FIG. 1 is a block diagram of an example cellular network 100. The cellular network 100 is an example of a 5G-ORAN network. The example cellular network 100 can be a private 5G network, for example. A private 5G network can be associated with a particular enterprise or organization. A private 5G network can be a mobile private network, or a fixed private network. Although the cellular network 100 is described as a 5G network, the cellular network 100 can be any network that provides connectivity using wireless communication technologies.

The cellular network 100 can have particular services, functions, applications, devices, and protocols. The services, functions, and applications can be provided by various vendors and other third party entities. For example, services, functions, and applications can include video streaming, digital voice, or a message network function. Example network functions shown in FIG. 1 include Access and Mobility Management Function (AMF), Session Management Function (SMF), Authentication Server Function (AUSF), Policy Control Function (PCF), Unified Data Management (UDM), and Application Function (AF).

The cellular network 100 can have its own radio unit (e.g., radio unit 104) and other communication infrastructures. For example, the radio unit 104 can be a gNodeB node. The cellular network 100 can have its own users and user equipment (UE 106, 108, and 110) that are authenticated to access the cellular network 100.

The user equipment 106, 108, and 110 can access different services and network functions during a user session. For example, the user equipment 106, 108, and 110 can each be a user device that is configured to communicate with services, functions, applications, and other user devices through the cellular network 100. The cellular network 100 can receive data from and send data to the user equipment through data packets. For example, as a user of the user equipment performs different actions during the user session, data packets relevant to the different actions can be routed through the cellular network 100. A data packet routed through the cellular network 100 may be routed through different services and functions. The techniques described in this specification allow for tracking of the route of the data packet and other relevant metadata information through the services and functions as described in further detail below.

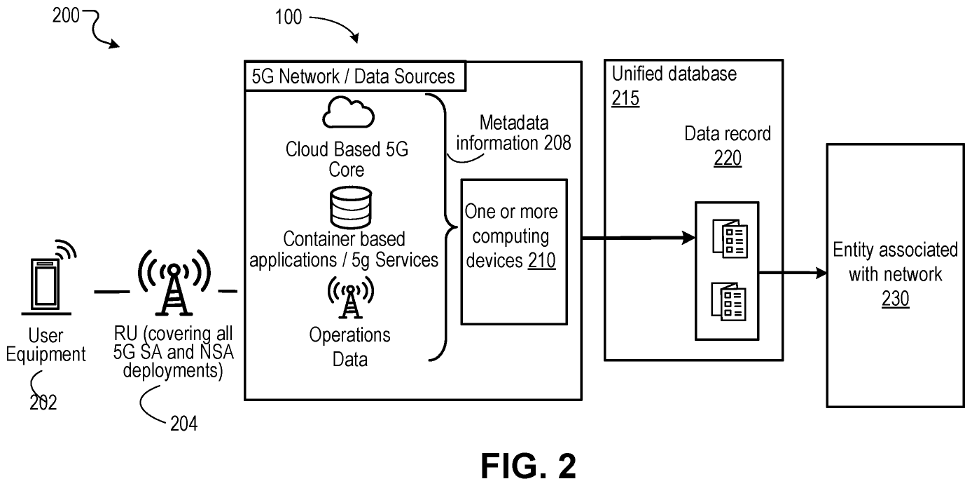

FIG. 2 is a block diagram of an example environment 200 for providing metadata information 208 associated with a route of and access to a data packet through various nodes of a cellular network. The cellular network can be the example cellular network 100 as described above with reference to FIG. 1. The environment 200 also includes user equipment 202, similar to the user equipment 106, 108, and 110 described above with reference to FIG. 1. The environment 200 also includes a radio unit (e.g., RU 204), one or more computing devices 210, a unified database 215, and an entity 230 associated with the cellular network 100.

The radio unit 204 is configured to allow the user equipment 202 to connect to the cellular network 100. The radio unit 204 can include any form of stand alone or non-stand alone radio unit deployments. Data packets can flow from the user equipment 202 and the radio unit 204, through the cellular network 100.

As depicted in FIG. 2, the cellular network 100 can include components such as a cloud based 5G core, container based applications, and container based 5G services. The cloud based 5G core can include core network functions. The container based applications and container based 5G services can represent various nodes of the cellular network 100. Each container based application or service can include one or more devices that can receive, access, and update data packets.

Each container based application or service, also referred to as a node, can include instructions from a third party entity that allow the third party entity to provide the functions of the application or service. For example, the instructions corresponding to each node can include instructions to access certain categories of data from a data packet that is routed to the node. Example services can include authentication or analytics.

Each node can be associated with a listener. Each listener can be configured to determine metadata information. For example, each listener can be configured to determine that a data packet is accessed by the node. In some implementations, each listener can be configured to determine that a data packet is accessed by one or more devices of the node. In some implementations, each listener can be configured to determine what categories of the data packet are accessed by the node. Each listener can also be configured what categories of data are present in the data packet, and/or where the data packet was routed from, and/or where the data packet is getting routed to.

The components of the cellular network 100 can generate metadata information 208. Metadata information 208 can include different categories. For example, metadata information 208 can include information about a category of data such as a name of the category of data or a description of the category of data.

Metadata information 208 can also include data indicative of a route of a data packet. Data indicative of a route of a data packet can include data that indicates which nodes accessed a category of data of the data packet. For example, when a data packet is routed to a particular node, the listener associated with the node can generate data indicating that the data packet was accessed by the node. For example, data indicative of a route of a data packet can include an identifier for the node. The data indicative of a route of a data packet can also include a geographical location of a device of the node, or the origin of the data packet.

Data indicative of a route of a data packet can also include tags. For example, a tag can be a regulatory tag that indicates the data packet was routed to a node that accessed a category of the data packet that has regulatory implications. A tag can be a privacy tag that indicates the data packet was routed to a node that accessed a category of the data packet that has privacy implications. For example, a category of data that can have privacy implications includes personally identifiable data. A tag can be a safety tag that indicates the data packet was routed to a node with safety implications. A tag can also be a timestamp tag that indicates the date and/or time that the data packet was routed to a particular node. A tag can also be consumer-defined. For example, an entity associated with the cellular network 100 can define tags for when certain categories of data are accessed.

Data indicative of a route of a data packet can also include classifications for categories of metadata. The classifications can indicate that there are certain actions associated with data associated with those categories of metadata. For example, classifications can include that the data is sensitive and should be masked, encrypted, and/or protected. Classifications also include a format for the data and should be stored in that format. Classifications can also include that the data is privileged and should be protected.

The metadata information 208 can also include operations data. Operations data can include, for example, data relating to the status of the cellular network 100. Operations data can also include data relating to the status of a component of the cellular network 100. For example, a component can include an autonomous robot. The operations data for the autonomous robot can include an identifier for the autonomous robot on the cellular network 100, an operating system version, a current device speed, telemetry data, location data, etc.

The network 100 can also include one or more computing devices 210. For example, one of the computing devices 210 can be a central device such as an orchestrator for the 5G core. The one or more computing devices 210 can be configured to receive metadata information 208 and to create or update metadata records such as a metadata record 220 to include the metadata information 208. The one or more computing devices 210 can receive metadata information 208 from the listeners described above.

For example, upon receiving an update from a listener of a node of the cellular network 100, the one or more computing devices can access the unified database 215. In some examples, the one or more computing devices 210 may determine that the unified database 215 does not include a corresponding metadata record for the data packet of the update from the listener. The one or more computing devices can generate a new metadata record representing the new data packet in the unified database 215. In other examples, the one or more computing devices 210 may determine that the unified database 215 already includes a corresponding metadata record for the data packet of the update from the listener. The one or more computing devices 210 can update the metadata record for the data packet.

The one or more computing devices 210 can also be configured to perform actions based on the metadata information 208. For example, the one or more computing devices 210 can determine that a category of the metadata information 208 is associated with an action using the classifications. In response to determining that the category is associated with an action, the one or more computing devices 210 can perform the action. The action can include modifying the data associated with the metadata information 208. For example, the action can include encrypting data associated with the category, masking data associated with the category, protecting data associated with the category, labeling the category, or formatting data associated with the category. The data associated with the metadata information 208, that is, the data of the data packet for which the metadata information 208 includes information about, may be stored at various data centers that the one or more computing devices 210 can access.

As an example, a category of data can include healthcare information. The corresponding classification for the category of the metadata information 208 can indicate that healthcare information is private. The category of the metadata information 208 can be associated with an action of encrypting the healthcare information. As another example, a category of data can include sensitive data that is to be protected for downstream applications. The corresponding classification for the category of the metadata information 208 can be labeled to indicate that the data associated with the category is to be protected before providing the information for downstream tasks.

A metadata record 220 can include metadata information 208 for a data packet that is routed through the cellular network 100. Each metadata record 220 can include one or more categories of metadata information 208 for the data packet. For example, the metadata record 220 can include data indicative of the data packet's route through the cellular network 100. The metadata record 220 can include an additional header for each service that the data packet was routed to. Tags and classifications can also be included as additional headers in the metadata record 220, for example.

Metadata records corresponding to multiple data packets can be stored in the unified database 215. The unified database 215 can be maintained to keep track of various data packets traversing the cellular network 100. For example, the unified database 215 can be a relational database, a graph database, or a combination of multiple types of databases. In some implementations, the unified database 215 can be stored at the one or more computing devices 210. In some implementations, the unified database 215 can include definitions or descriptions of the metadata information of the metadata records 220.

The environment 200 includes an entity 230 associated with the network. For example, the entity 230 associated with the network can be a consumer, a third-party vendor, a subscriber, or a service provider associated with the network 100. The entity 230 associated with the network can query the unified database 215 for information of the metadata records 220. For example, the entity 230 associated with the network can query the one or more computing devices 210 for information stored in the unified database 215 using an application programming interface (API).

For example, a query can include a request for information about the route of a particular data packet through the cellular network 100. For example, the entity 230 may want to obtain information related to what route a particular data packet from a particular user session of the user equipment 202 took through the cellular network 100.

The entity 230 associated with the network can also be an auditing entity. For example, the entity 230 may be a regulatory agency that may want to obtain information relevant to compliance, safety, or privacy. A query can thus include a compliance-related query that includes a request for information about which nodes accessed certain categories of data of data packets. For example, the entity 230 may want to obtain information related to which data packets were routed through nodes that are associated with certain tags.

The one or more computing devices 210 can provide information stored in the unified database 215 that addresses the query. For example, if the query includes a compliance-related query, the one or more computing devices 210 can filter the metadata records of the unified database 215 based on the tag associated with the compliance-related query. The one or more computing devices 210 can provide information relating to the subset of metadata records that include the tag.

The entity 230 associated with the network can receive information through a user-interface. For example, the network 100 can provide a user-interface for presentation on a user device of the entity 230 associated with the network. The user-interface can be configured to represent information from the unified database 215. For example, the information can include metadata records from the unified database 215 filtered in accordance with one or more tags in response to a query from the entity 230.

Thus, in order to respond to a query from the entity 230, the one or more computing devices 210 can maintain and add metadata information 208 about data packets routed through the network 100 in the unified database 215. The metadata information that is maintained for each data packet in the unified database 215 can be used for downstream processing tasks. For example, data packets can be classified based on the categories of metadata, or filtered by the tags or the classifications. Furthermore, data packets with standardized metadata information or data can be processed by downstream applications.

Examples of downstream applications include real-time monitoring of sensitive data assets, data entitlement and access management, data lifecycle management, risk management, and analytics. Another example includes user entity behavior analytics or predictive cyber analytics that allows one or more computing devices of the network 100 to monitor, flag, and stop suspicious behavior such as unauthorized data access.

As an example, the entity 230 can be a consumer of the cellular network 100. The entity 230 may want to obtain information regarding which data packets were accessed by particular services during a certain period of time. For example, the entity 230 may have had a security breach and a regulatory agency may want to know what data packets with personally identifiable information were accessed by which services during the period of time. The one or more computing devices of the cellular network 100 can efficiently provide information regarding which data packets with personally identifiable information were accessed, and by which services. For example, the one or more computing devices can filter the metadata records 220 of the unified database 215 by the privacy tag. The one or more computing devices can then provide the data indicative of the data packet's route through the cellular network 100 during the period of time for each of the data packets corresponding to the filtered metadata records.

As another example, the entity 230 can use the metadata information to ensure that sensitive data or data that should be protected stays protected during downstream processing. For example, the metadata information can include a classification that indicates the data associated with the category includes personally identifiable information. The entity 230 can receive the classifications and implement data use policies that comply with the classifications.

As another example, the entity 230 can use the metadata information to automate storage and retention policies for data. For example, the entity 230 can be a provider of one of the services of the cellular network 100. The entity 230 may have a data retention policy of storing certain types of data, such as personally identifiable data or medical-related data, in easily accessible but computationally costly storage for a certain period of time before moving the data to less easily accessible but computationally efficient storage. Conventional techniques for adhering to the retention policy may require the entity 230 to manually review the data and when the data was received by the entity 230. This can result in delays in moving the data to computationally efficient storage. The techniques described in this specification can provide metadata information to the entity 230 that includes the timestamp of the access of the service to data packets. The metadata information can be used to drive automation of the retention policy, so that data is more efficiently stored and the retention policy is more easily adhered to when compared to conventional techniques.

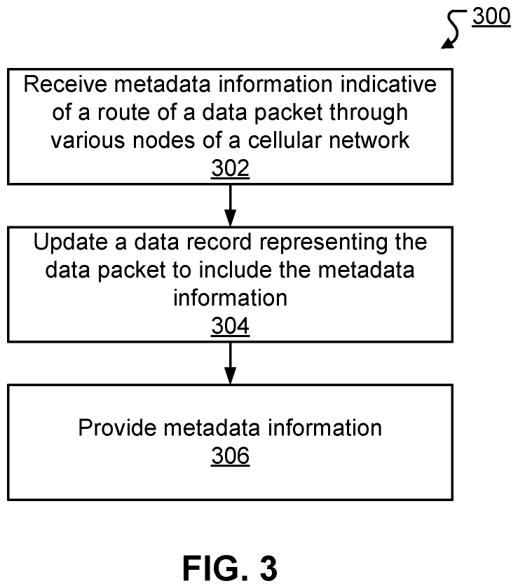

FIG. 3 is a flow diagram of an example process 300 for providing metadata information associated with a route of a data packet through various nodes of a cellular network.

At step 302, one or more computing devices receive metadata information indicative of a route of a data packet through various nodes of a cellular network. For example, a node of the various nodes can include a service, a device, or an application of the cellular network. For example, the one or more computing devices can receive metadata information from one or more listeners as described above with reference to FIG. 2.

At step 304, the one or more computing devices update a metadata record representing the data packet to include the metadata information. The metadata information is indicative of a route of the data packet through the various nodes. The metadata record can be a portion of a unified database maintained to keep track of various data packets traversing the cellular network. In some implementations, the unified database can be a relational database. In some implementations, the unified database can be a graph database. In some implementations, the unified database can be a combination of different types of databases, such as a combination of a relational database and a graph database. The metadata information can include information such as operational data, tags, and classifications.

At step 306, the one or more computing devices provide metadata information. For example, the one or more computing devices can provide metadata information associated with the route of the data packet through the various nodes in response to a query received from an entity associated with the cellular network. For example, the one or more computing devices can provide metadata information to a network operator of the cellular network or another entity associated with the cellular network. In some implementations, the one or more computing devices can provide the metadata information through a portal or application programming interface (API).

In some implementations, the metadata information indicative of the route of the data packet through the various nodes can include one or more tags corresponding to the one or more of the various nodes. For example, the tags can include regulatory tags, privacy tags, timestamp tags, or safety tags. The tags can also include consumer-defined tags.

The tags can allow for metadata information to be easily filtered and sorted. For example, the query can include a compliance-related query. Providing the metadata information can include filtering the metadata records of the unified database by the one or more tags associated with the compliance-related query. The one or more computing devices can then provide information associated with the route of one or more data packets associated with metadata records corresponding to the one or more tags.

For example, a regulatory tag can indicate the data packet was routed to a node that accessed a category of the data packet that has regulatory implications, such as a sensitive category of data. A privacy tag can indicate the data packet was routed to a node that accessed a category of the data packet that has privacy implications, such as personally identifiable information. A safety tag can indicate the data packet was routed to a node with safety implications, such as information related to operating conditions. A timestamp tag can indicate the date and/or time that the data packet was routed to a particular node. A consumer-defined tag can indicate the data packet was routed to a node that accessed a category of the data packet that was defined by the user to be important.

In some implementations, the metadata information can include classification data for categories of metadata information. A classification for a particular category can indicate that one or more actions are associated with the particular category.

In some implementations, the one or more computing devices can determine that a category of one or more categories of metadata information is associated with an action for the category. For example, the one or more computing devices can determine that a category is associated with a classification. For example, the action can include encrypting data associated with the category, masking data associated with the category, protecting data associated with the category, formatting data associated with the category, or labeling the category. In response to determining that the category is associated with an action for the category, the one or more computing devices can perform the action.

For example, if the action is encrypting data associated with the category, the one or more computing devices can encrypt the data associated with the category. If the action is masking data associated with the category, the one or more computing devices can mask the data associated with the category. If the action is protecting data associated with the category, the system can protect the data associated with the category through encryption, masking, or password protection, for example. If the action is formatting data associated with the category, the one or more computing devices can update the format of the data associated with the category to a standard format. If the action is labeling the category, the system can add additional metadata to the category that indicates that data associated with the category is to be modified.

In some implementations, the one or more computing devices can provide a user-interface for presentation on a user device. The user-interface can be configured to represent information from the unified database. For example, the information can include metadata records from the unified database filtered in accordance with one or more tags.

In some implementations, the one or more computing devices may create new metadata records in the unified database. For example, new data packets may flow through the network that do not have an existing metadata record in the unified database. The one or more computing devices can receive metadata information indicative of a route of a second data packet through the cellular network. The one or more computing devices can determine that the unified database does not include a corresponding metadata record for the second data packet. In response to determining that the unified database does not include a corresponding metadata record for the second data packet, the one or more computing devices can generate a second metadata record representing the second data packet in the unified database.

The particular order of steps in the process 300 described above is for illustrative purposes, and the process 300 may be performed in other orders. In some implementations, the process 300 can include additional steps, fewer steps, or some of the steps can be divided into multiple steps.

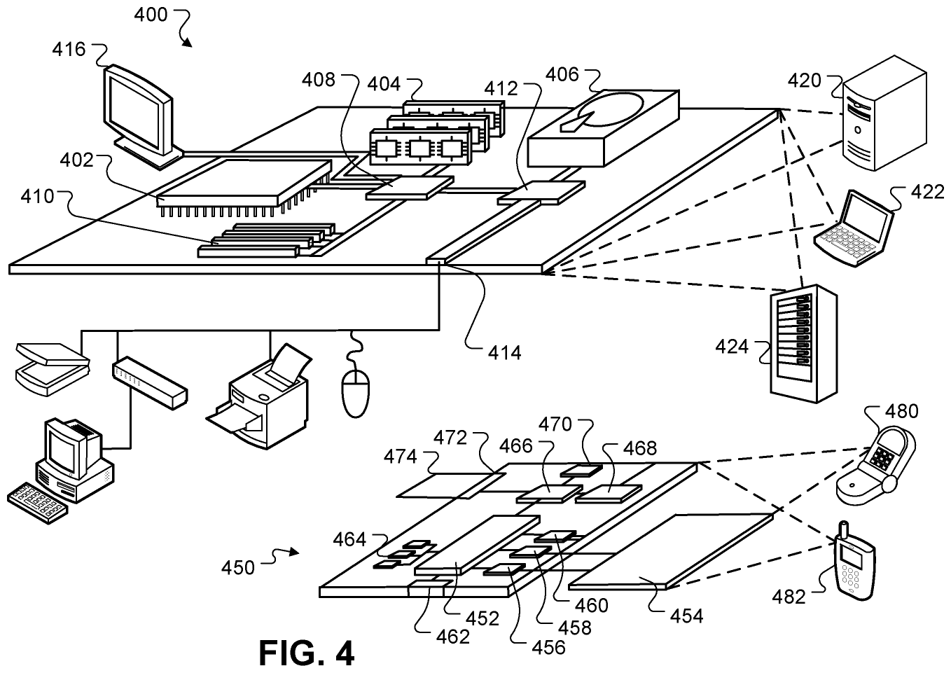

FIG. 4 shows an example of a computing device 400 and a mobile computing device 450 (also referred to herein as a wireless device) that are employed to execute implementations of the present disclosure. The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting. The computing device 400 and/or the mobile computing device 450 can form at least a portion of the environment for providing metadata information described above. For example, a computing device 400, or a portion thereof, can be used to implement the user equipment 202, one or more computing devices 210, and unified database 215, described with reference to FIG. 2. In some examples, a laptop computer 422 can be used to implement the user equipment 202 described with reference to FIG. 2. In some examples, a mobile computing device 450 can be used to implement the user equipment 202 described with reference to FIG. 2.

The computing device 400 includes a processor 402, a memory 404, a storage device 406, a high-speed interface 408, and a low-speed interface 412. In some implementations, the high-speed interface 408 connects to the memory 404 and multiple high-speed expansion ports 410. In some implementations, the low-speed interface 412 connects to a low-speed expansion port 414 and the storage device 406. Each of the processor 402, the memory 404, the storage device 406, the high-speed interface 408, the high-speed expansion ports 410, and the low-speed interface 412, are interconnected using various buses, and may be mounted on a common motherboard or in other manners as appropriate. The processor 402 can process instructions for execution within the computing device 400, including instructions stored in the memory 404 and/or on the storage device 406 to display graphical information for a graphical user interface (GUI) on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 404 stores information within the computing device 400. In some implementations, the memory 404 is a volatile memory unit or units. In some implementations, the memory 404 is a non-volatile memory unit or units. The memory 404 may also be another form of a computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 402, perform one or more methods, such as those described above. The instructions can also be stored by one or more storage devices, such as computer-readable or machine-readable mediums, such as the memory 404, the storage device 406, or memory on the processor 402.

The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards. In the implementation, the low-speed interface 412 is coupled to the storage device 406 and the low-speed expansion port 414. The low-speed expansion port 414, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 414 through a network adapter. Such network input/output devices may include, for example, a switch or router.

The computing device 400 may be implemented in a number of different forms, as shown in the FIG. 4. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may contain one or more of the computing device 400 and the mobile computing device 450, and an entire system may be made up of multiple computing devices communicating with each other.

The mobile computing device 450 includes a processor 452; a memory 464; an input/output device, such as a display 454; a communication interface 466; and a transceiver 468; among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate. In some implementations, the mobile computing device 450 may include a camera device(s) (not shown).

The processor 452 can execute instructions within the mobile computing device 450, including instructions stored in the memory 464. The processor 452 may be implemented as a chipset of chips that include separate and multiple analog and digital processors. For example, the processor 452 may be a Complex Instruction Set Computers (CISC) processor, a Reduced Instruction Set Computer (RISC) processor, or a Minimal Instruction Set Computer (MISC) processor. The processor 452 may provide, for example, for coordination of the other components of the mobile computing device 450, such as control of user interfaces (UIs), applications run by the mobile computing device 450, and/or wireless communication by the mobile computing device 450.

The processor 452 may communicate with a user through a control interface 458 and a display interface 456 coupled to the display 454. The display 454 may be, for example, a Thin-Film-Transistor Liquid Crystal Display (TFT) display, an Organic Light Emitting Diode (OLED) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a Single in Line Memory Module (SIMM) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provided as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 452, perform one or more methods, such as those described above. The instructions can also be stored by one or more storage devices, such as one or more computer-readable or machine-readable mediums, such as the memory 464, the expansion memory 474, or memory on the processor 452. In some implementations, the instructions can be received in a propagated signal, such as, over the transceiver 468 or the external interface 462.

The mobile computing device 450 may communicate wirelessly through the communication interface 466, which may include digital signal processing circuitry where necessary. The communication interface 466 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 468 using a radio frequency. In addition, short-range communication, such as using a Bluetooth or Wi-Fi, may occur. In addition, a Global Positioning System (GPS) receiver module 470 may provide additional navigation- and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, etc.) and may also include sound generated by applications operating on the mobile computing device 450.

The mobile computing device 450 may be implemented in a number of different forms, as shown in FIG. 4. For example, it may be implemented in the user equipment described with respect to FIGS. 1-2. Other implementations may include a phone device 482 and a tablet device 484. The mobile computing device 450 may also be implemented as a component of a smart-phone, personal digital assistant, AR device, or other similar mobile device.

Computing device 400 and/or 450 can also include USB flash drives. The USB flash drives may store operating systems and other applications. The USB flash drives can include input/output components, such as a wireless transmitter or USB connector that may be inserted into a USB port of another computing device.

A number of implementations have been described. While this specification contains many specific implementation details, these should not be construed as limitations on the scope of what is being claimed, which is defined by the claims themselves, but rather as descriptions of features that may be specific to particular implementations. It will be understood that various modifications may be made.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

Accordingly, other implementations are within the scope of the claims.

What is claimed is:

1. A computer-implemented method comprising:
receiving, at one or more computing devices, metadata information indicative of a route of a data packet through various nodes of a cellular network;
updating, by the one or more computing devices, a metadata record representing the data packet to include the metadata information indicative of a route of the data packet through the various nodes, the metadata record being a portion of a unified database maintained to keep track of various data packets traversing the cellular network; and
providing, in response to a query received from an entity associated with the cellular network, metadata information associated with the route of the data packet through the various nodes.

2. The method of claim 1, wherein a node of the various nodes comprises any one of: a service, a device, or an application.

3. The method of claim 1, further comprising:
determining that a category of one or more categories of metadata information is associated with an action for the category, wherein the action comprises any one of encrypting data associated with the category, masking data associated with the category, protecting data associated with the category, formatting data associated with the category, or labeling the category; and
responsive to determining that the category is associated with an action for the category, performing the action.

4. The method of claim 1, wherein the metadata information indicative of the route of the data packet through the various nodes comprises one or more tags corresponding to the one or more of the various nodes.

5. The method of claim 4, wherein the one or more tags comprise any one of: a regulatory tag, a privacy tag, a timestamp tag, or a safety tag.

6. The method of claim 4, wherein the one or more tags are consumer-defined.

7. The method of claim 4, wherein the query comprises a compliance-related query, and providing the metadata information comprises:
filtering metadata records of the unified database by the one or more tags associated with the compliance-related query; and
providing information associated with the route of one or more data packets associated with metadata records corresponding to the one or more tags.

8. The method of claim 1, wherein the method further comprises:
receiving metadata information indicative of a route of a second data packet through the cellular network;
determining that the unified database does not include a corresponding metadata record for the second data packet; and
responsive to determining that the unified database does not include a corresponding metadata record for the second data packet, generating a second metadata record representing the second data packet in the unified database.

9. The method of claim 1, wherein the unified database is any one or more of: a relational database or a graph database.

10. The method of claim 1, further comprising providing a user-interface for presentation on a user device, the user-interface configured to represent information from the unified database, the information comprising metadata records from the unified database filtered in accordance with one or more tags.

11. A non-transitory, computer-readable medium storing one or more instructions executable by a computer system to perform operations comprising:
receiving, at one or more computing devices, metadata information indicative of a route of a data packet through various nodes of a cellular network;
updating, by the one or more computing devices, a metadata record representing the data packet to include the metadata information indicative of a route of the data packet through the various nodes, the metadata record being a portion of a unified database maintained to keep track of various data packets traversing the cellular network; and
providing, in response to a query received from an entity associated with the cellular network, metadata information associated with the route of the data packet through the various nodes.

12. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, at one or more computing devices, metadata information indicative of a route of a data packet through various nodes of a cellular network,
updating, by the one or more computing devices, a metadata record representing the data packet to include the metadata information indicative of a route of the data packet through the various nodes, the metadata record being a portion of a unified database maintained to keep track of various data packets traversing the cellular network, and
providing, in response to a query received from an entity associated with the cellular network, metadata information associated with the route of the data packet through the various nodes.

13. The system of claim 12, wherein a node of the various nodes comprises any one of: a service, a device, or an application.

14. The system of claim 12, wherein the operations further comprise:
determining that a category of one or more categories of metadata information is associated with an action for the category, wherein the action comprises any one of encrypting data associated with the category, masking data associated with the category, protecting data associated with the category, formatting data associated with the category, or labeling the category; and
responsive to determining that the category is associated with an action for the category, performing the action.

15. The system of claim 12, wherein the metadata information indicative of the route of the data packet through the various nodes comprises one or more tags corresponding to the one or more of the various nodes.

16. The system of claim 15, wherein the one or more tags comprise any one of: a regulatory tag, a privacy tag, a timestamp tag, or a safety tag.

17. The system of claim 15, wherein the one or more tags are consumer-defined.

18. The system of claim 15, wherein the query comprises a compliance-related query, and providing the metadata information comprises:
filtering metadata records of the unified database by the one or more tags associated with the compliance-related query; and
providing information associated with the route of one or more data packets associated with metadata records corresponding to the one or more tags.

19. The system of claim 12, wherein the operations further comprise:
receiving metadata information indicative of a route of a second data packet through the cellular network;
determining that the unified database does not include a corresponding metadata record for the second data packet; and
responsive to determining that the unified database does not include a corresponding metadata record for the second data packet, generating a second metadata record representing the second data packet in the unified database.

20. The system of claim 12, wherein the unified database is any one or more of: a relational database or a graph database.
